(19) United States
(12) Patent Application Publication
(10) Pub. No.: US 2013/0271376 A1
(43) Pub. Date: Oct. 17, 2013

(54) Touch Keyboard

(71) Applicants: WISTRON CORPORATION, New Taipei City (TW); ETURBOTOUCH TECHNOLOGY INC., Taoyuan County (TW)

(72) Inventors: Kuei-Ching Wang, New Taipei City (TW); Ta-Hu Lin, New Taipei City (TW)

(73) Assignees: eTurboTouch Technology Inc., Taoyuan County (TW); Wistron Corporation, New Taipei City (TW)

(21) Appl. No.: 13/858,940

(22) Filed: Apr. 8, 2013

(30) Foreign Application Priority Data
Apr. 13, 2012 (TW) 101113235

(51) Int. Cl. G06F 3/02; G06F 3/041

(52) U.S. Cl. CPC G06F 3/02; G06F 3/0412
USPC 345/168

(57) ABSTRACT

A touch keyboard includes a touch input panel having a touch input surface, a plurality of key zones and a tracking input zone. The touch input panel physically presents the key zones on the touch input surface. The tracking input zone is located between at least two of the key zones.

### BACKGROUND OF THE INVENTION

1. Field of the Invention

The present invention relates to an input device and a processing method thereof, and more particularly, to a touch input device and a processing method thereof.

2. Description of the Prior Art

Currently more and more electronic products, such as mobile phones and tablet computers, have included touch screens as user input interfaces . A touch screen allows a user to directly click on objects to open or execute the objects, or displays virtual keys for the user to input texts or give commands.

The conventional touch screen includes a display device and a touch input panel, wherein the touch input panel is disposed on a display surface of the display device. The touch input panel mostly works in coordination with the display device. For example, the display device displays icons for the user to touch and select a corresponding area on the touch input panel, or the display device displays a cursor for the user to move the cursor on the touch input panel. If the touch screen is used as a keyboard, the display device needs to display a complete set of keys or most keys of the keyboard, and the user can touch or click areas corresponding to the keys on the touch input panel to generate key inputs thereafter.

The conventional touch input panel needs to work in collaboration with the display device in order to display a discernible key area, and the user can therefore see the virtual keys displayed by the display device and touch the corresponding area in the touch input panel to generate the key-pressing signal. In other words, the conventional touch input panel does not have an independent keyboard function, and can not be used as a single input device of key-pressing. Moreover, the conventional touch screen does not provide interfaces for mouse operation or tracking input in the keyboard.

Therefore, how to provide a touch keyboard which can independently operate, and simultaneously provide two or more input interfaces for the user has become an important topic in the industry.

### SUMMARY OF THE INVENTION

It is therefore an objective of the present invention to provide a touch keyboard capable of being operated independently and allowing users to operate simultaneously by two or more input interfaces.

To achieve the objective mentioned above, the touch keyboard of the present invention includes a touch input panel . The touch input panel includes a touch input surface, a plurality of key zones and a tracking input zone, and physically presenting the key zones on the touch input surface, wherein the tracking input zone is located among at least two key zones.

In an embodiment, the tracking input zone is located in the center of the touch input surface.

In another embodiment, the tracking input zone is physically presented on the touch input surface.

In another embodiment, the tracking input zone is defined by a contour, and the contour includes a shape of a circle, a triangle, a rectangle, a pentagon, a hexagon, or a star.

In another embodiment, the tracking input zone is located among key zones corresponding to keys Y, U, and H, or among key zones corresponding to keys Y, G, and H.

In another embodiment, the contour of the tracking input zone and outlines of the key zones near the tracking input zone correspond to each other.

In another embodiment, the tracking input zone is not physically presented on the touch input surface, where the outlines of key zones near the tracking input zone indicate the position of the tracking input zone.

In another embodiment, the touch keyboard further includes a housing, which contains the touch input panel.

In another embodiment, a gap is formed between the key zones, wherein the touch input panel further includes a plurality of row conducting wires that cross each other with a plurality of column conducting wires, wherein each of the key zone covers at least one cross point of row conducting wires and column conducting wires.

In another embodiment, the touch input panel is either a resistive touch panel or a capacitive touch panel.

In another embodiment, the touch input panel is a flexible touch input panel.

Followed by the description of above, the touch keyboard of the present invention specifically includes a tracking input zone among at least two key zones, wherein the tracking input zone is used as an alternative input interface of non-keystroke. Therefore, the touch keyboard provides a user to simultaneously perform both a keystroke operation and another interface of non-keystroke. The tracking input zone may be located in the center of the touch input panel, for example, among keys Y, G, and H, so that the user can conveniently operate such as using an index finger to slip around within the tracking input zone to generate input signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are schematic diagrams of touch keyboards according to embodiments of the invention.

FIG. 4 is a block diagram of the touch keyboards shown in FIG. 1 to FIG. 3.

FIG. 5 is a top-view diagram for a partial structure of a touch input panel in a touch keyboard according to an embodiment of the invention.

### DETAILED DESCRIPTION

Descriptions below refer to the related figures to illustrate a touch keyboard according to the preferred embodiments of the present invention, wherein the same elements are illustrated by the same symbols of denotation.

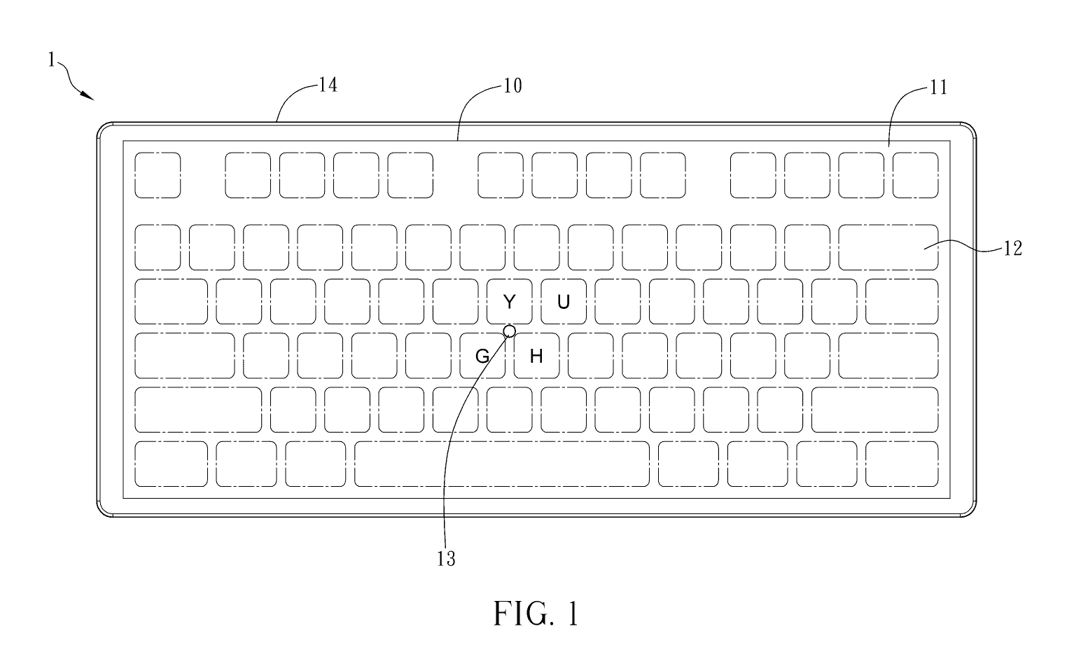

FIG. 1 to FIG. 3 are schematic diagrams of touch keyboards according to embodiments of the invention. As shown in FIG. 1, a touch keyboard 1 includes a touch input panel 10. The touch input panel 10 includes a touch input surface 11, a plurality of key zones 12, and a tracking input zone 13, wherein the touch input panel 11 physically presents the key zone 12, and the tracking input zone 13 is located among at least two key zones 12. Each key zone 12 and the tracking input area 13 generate input signals according to touching inputs of a user. For example, when the key zone 12 is touched, the touch keyboard 1 generates a keystroke signal and the tracking input zone 13 generates a tracking signal. The touch keyboard 1 further includes a housing 14, which contains the touch input panel 10.

In this embodiment, the touch keyboard is arranged as a standard keyboard, and the key zones 12 represent keys of the standard keyboard, such as A to Z, F1-F12, Alt, Ctrl, Space, Enter, Backspace, Home, End, Page Up, Page Down, etc . Each key zone 12 is disposed in a position in the touch input panel 10 according to a position corresponding to a represented key in the standard keyboard.

The key zones 12 are defined within areas of the touch input surface 11, which can effectively generate input signals. Each key zone 12 is an independent key, and generates an input signal corresponding to a represented key. The tracking input zone 13 can be used as a trackball, which simulates operations of the trackball, such that the user can move a finger or touch pen to generate a tracking input in the tracking input zone 13, and the touch keyboard 1 can output movement data accordingly.

The tracking input zone 13 can be located in the center of the touch input surface 11, to facilitate user's operation, for example, by using the index finger to slip around within the tracking input zone 13 to generate the input signals. Therefore, the user can simultaneously operate the key zone 12 and another input interface of non-keystroke.

As shown in FIG. 1, the tracking input zone 13 is located among the key zones 12 representing Y, G, and H, and is physically presented in the touch input surface 11, so that the user can clearly see the denoted contour of the tracking input zone 13. The shape of the tracking input zone 13 is a small circle, with an area not significant to affect the sizes of the nearby key zones 12.

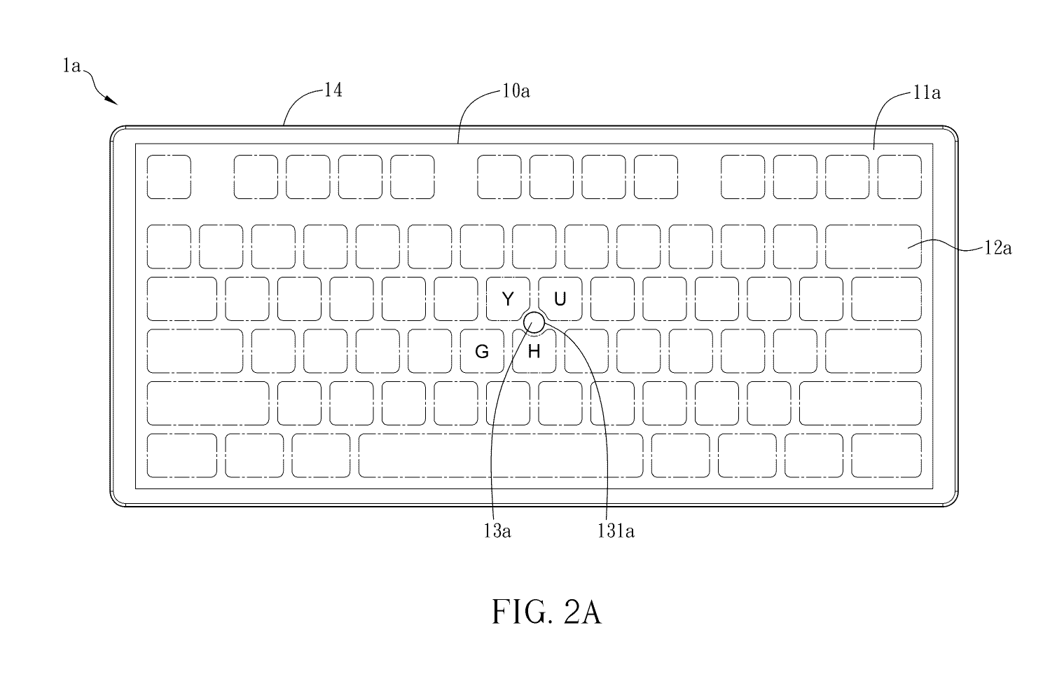

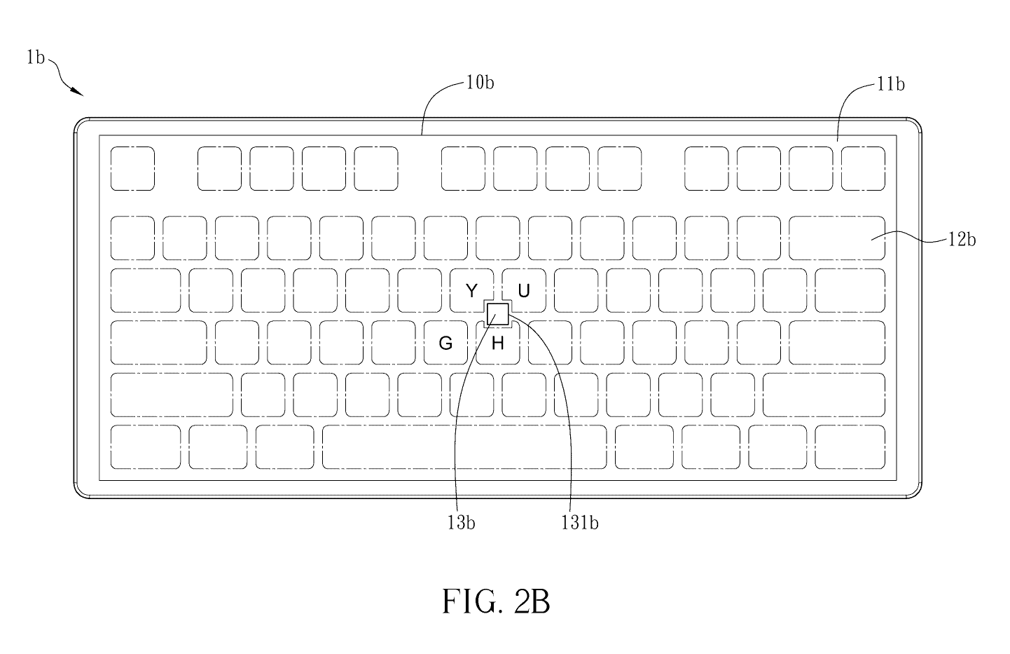

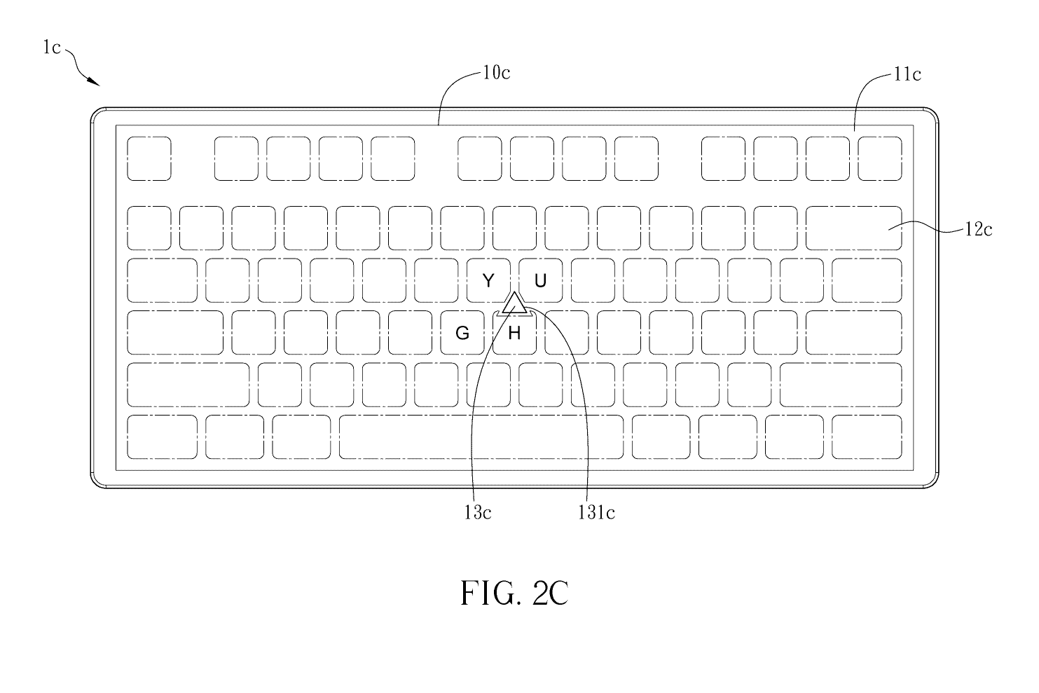

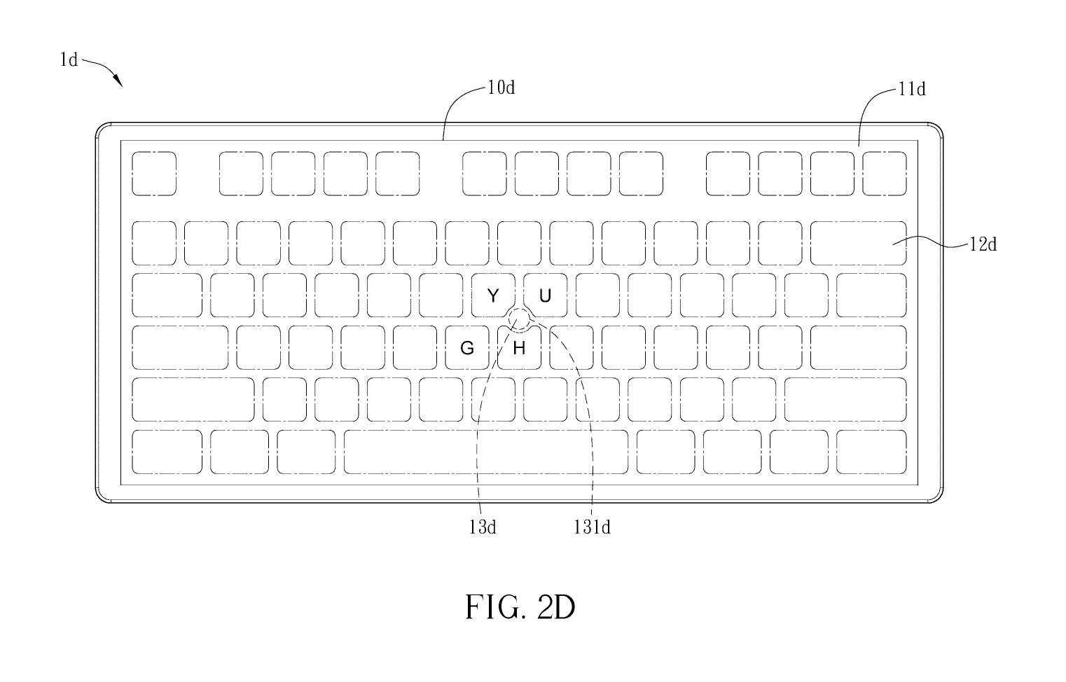

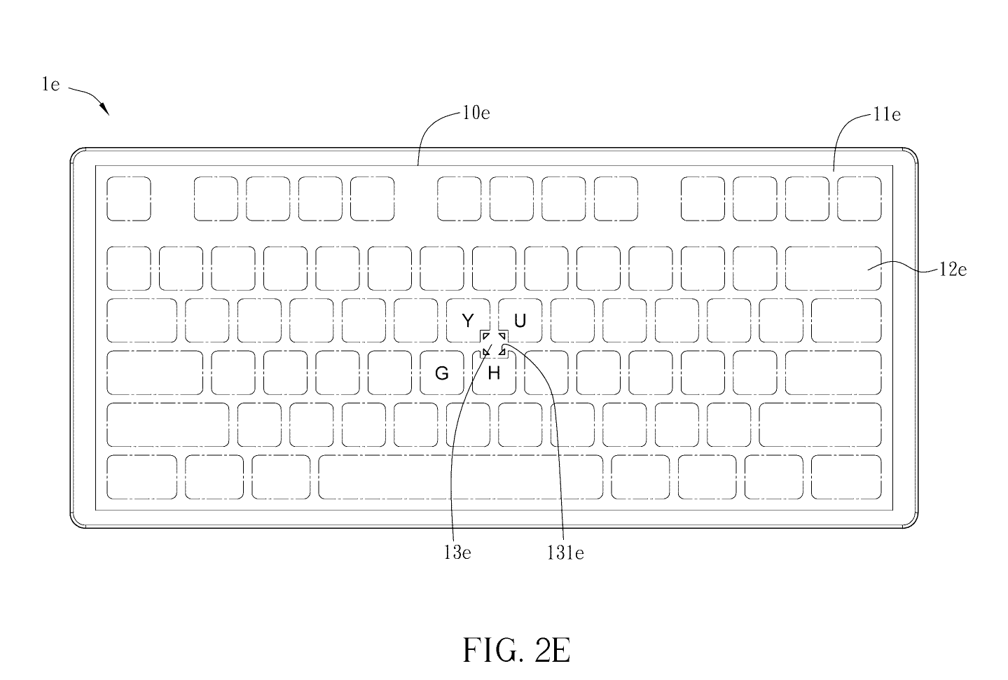

As shown in FIG. 2A, the tracking input zone 13a in the touch keyboard la is located among the key zones 12a representing Y, U, and H, and is physically presented in the touch input surface 11a. The tracking input zone 13a is defined by the contour 131a, and the contour 131a is a circle. The contour 131a and the outline of nearby key zones 12a correspond to each other.

Please refer to FIG. 2B. The touch keyboard 1b and the touch input surface 11b thereof are roughly the same as above-mentioned touch keyboard 1a and the touch input surface 11a thereof, and the tracking input zone 13b can be located among the key zones 12b representing Y, U, and H, and is physically presented in the touch input surface 11b. The only difference is that the contour 131b for defining the tracking input zone 13b is a square, and the contour 131b and outline of the nearby key zones 131b correspond to each other.

Please refer to FIG. 2C. The touch keyboard 1c and the touch input surface 11c thereof are similar to the touch keyboard 1a and the touch input surface 11a described above, and the tracking input zone 13c can be also located among the key zones 12c representing Y, U, and H, and is physically presented in the touch input surface 11c. The only difference is that the contour 131c for defining the tracking input zone 13c is a triangle, and the contour 131c and the outline of nearby key zones 131c correspond to each other.

Certainly, in other embodiments, the contour for defining the tracking input zone can be different shapes, such as a pentagon, a hexagon or a star, and is not limited thereto. Please refer to FIG. 2D. In addition to the shape differences, the touch keyboard ld and the touch input surface 11d thereof are similar to the touch keyboard la and the touch input surface 11a described above. Besides, the tracking input zone 13d is defined on the touch input panel 10d and the touch input surface 11d thereof. However, the contour 131d of the tracking input zone 13d can be formed by discontinuous straight lines, e.g. dotted lines shown in FIG. 2D. Furthermore, please refer to FIG. 2E, where the touch keyboard 1e and the touch input surface 11e thereof are also similar to the touch keyboard 1a and the touch input surface 11a described above, and the tracking input zone 13e is defined on the touch input panel 10e and the touch input surface 11e thereof. However, the contour 131e of the tracking input zone 13e can be formed by multiple symbols (e.g. triangle symbols shown in FIG. 2E), in which the shape of the symbol is not limited thereto.

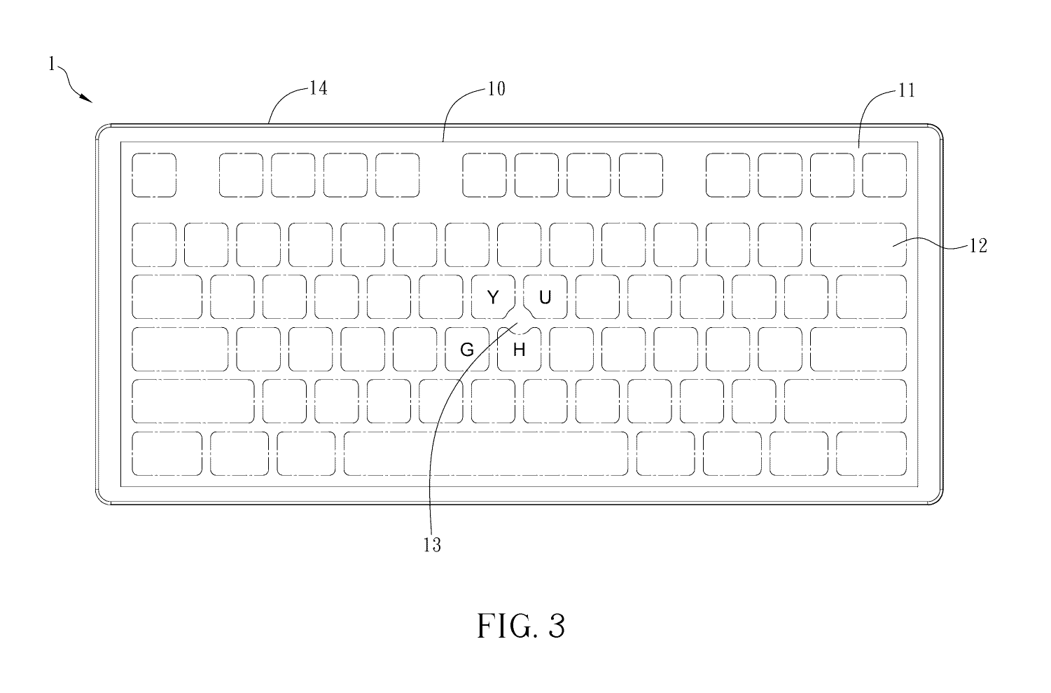

As shown in FIG. 3, the tracking input zone 13 is located among the key zones 12 representing Y, U, and H. Although the tracking input zone 13 is not physically presented in the touch input surface 11, the outlines of key zones 12 near the tracking input zone 13 are designed with notch shapes, which visually form a circle as a hint of the location of the tracking input zone 13.

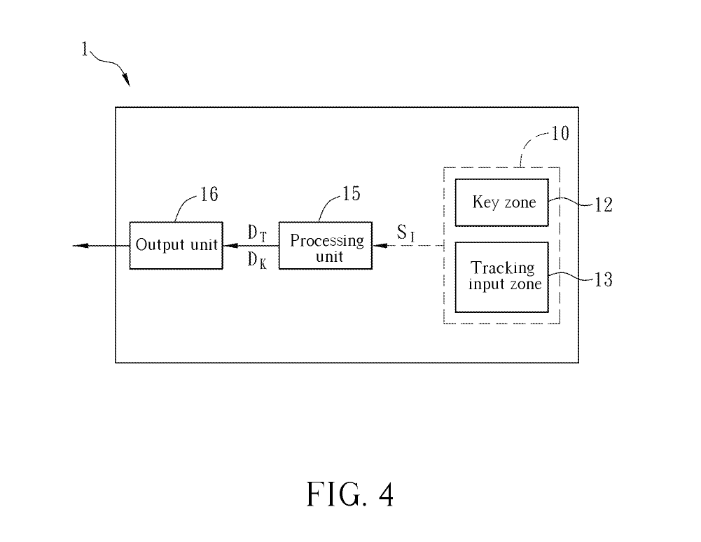

As shown in FIG. 4, the touch keyboard 1 further includes a processing unit 15 and an output unit 16. The processing unit 15 and the output unit 16 may be disposed in the touch input panel 10. The input signals generated by the key zone 12 and the tracking input zone 13 are processed by the processing unit 15. The output unit 16 is electrically connected to the processing unit 15. The processing unit 15 processes the input signal S_{I} outputted from the key zone 12 and the tracking input zone 13 in the touch input panel 10, and then outputs keystroke data D_{K} and tracking data D_{T} through the output unit 16. These data may be outputted to an electronic device, such as a desktop computer, a laptop computer, a tablet computer, or any other computational device, or to an electronic device capable of receiving messages, such as a personal digital assistant (PDA), a smart phone, etc.

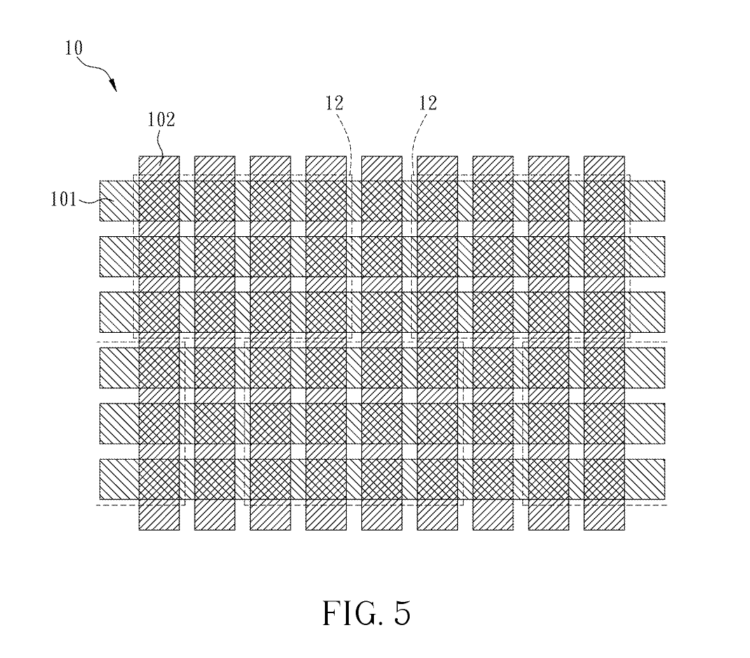

FIG. 5 shows a top-view diagram of a partial structure of the touch input panel of the touch keyboard according to an embodiment of the invention.

The touch input panel 10 may include a plurality of row conducting wires 101 and a plurality of column conducting wires 102 interlacedly arranged, wherein each of the key zones 12 covers at least one cross point of the row conducting wires 101 and the column conducting wires 102. There is a gap among the key zones 12. A part of cross points of the column conducting wires 101 and the row conducting wires 102 are not included within any of the key zones 12 and the tracking input zone 13, but within the gaps. The column conducting wires 101 and the row conducting wires 102 may be made of a transparent conducting material, such as Indium Tin Oxide (ITO).

The touch input panel 10 may be a digital matrix resistive touch panel. When the user presses on, the column conducting wires 101 and the row conducting wires 102 are conducted at cross points and generate input signals, and the input signals are transmitted from the cross points to the processing unit via corresponding column conducting wires 101 and row conducting wires 102. Besides, the touch input panel 10 prevents erroneous touches by different pressures.

When the keyboard operates, signals generated within the key zone 12 are considered as effective inputs, while signals generated within the gap are not considered as effective inputs, so as to simulate keystroke inputs.

Besides, the type of the touch input panel is not limited to the resistive touch panel, and may be a capacitive touch panel. Regardless of the type of the touch input panel, the touch input surface of the touch input panel is defined with a plurality of touch input points, which may be, for example, the cross points described above. A key zone covers the touch input points within the corresponding area without overlapping, i.e. a touch input point is not covered by two or more key zones . The touch input points not covered by the key zone are not considered as effective input points during the keystroke mode, but can be used as effective input points during the tracking input mode.

Moreover, from the above embodiments, the touch keyboard 1 does not utilize the display device to display a plurality of input areas, but directly forms a plurality of independent input key zones 12 in the touch input panel 10, i.e. physically defining the key zones 12 as the keystroke buttons in the touch input panel 10. Each key zone 12 displays the corresponding button respectively, for example, to form keystroke boundaries and a related pattern of text or symbol in inner and outer surfaces or inner and outer sides thereof for user's recognition. The manufacturing method may be, for example, printing, engraving, etc., or depositing colored phosphor or dye within the key zone 12 to arrange the colored phosphor or dye as the patterns of corresponding texts or symbols.

The touch input panel 10 mainly includes one or multiple plates . Taking multiple plates as an example, the touch input panel 10 mainly includes two plates which are separated by a middle separation material. The inner side of the both plates has a conductive layer, which can define a touch sensing circuit after printing, for example, a plurality of column conducting wires and row conducting wires or sensing pads. The two plates can both be substrates or film materials. The substrate plates may be made of glass or plastic, and the film plates may be made of acrylic, poly (methyl-methacrylate), or polycarbonate-based, etc.

The pattern of each key zone 12 can be formed by printing phosphor or dye on one of the plates, and arranging the phosphor or dye as the corresponding text or symbol. Besides, the outline of the tracking input zone 13 can be formed by printing on one of the plates. For example, the patterns of the key zones 12 and the tracking input zone 13 can be formed in the same plate.

Moreover, in a condition that the touch input panel 10 includes only one plate, one side of the plate has a conductive layer. The conductive layer can define a touch sensing circuit after printing, for example, a plurality of column conducting wires and row conducting wires, or sensing pads. The plates can be made of substrate or film. The pattern of each key zone 12 can be formed in one side of the plate by printing, for example, either in the same side or the other side of the conductive layer.

In the above embodiments, the touching keyboard is an example but not limited to being arranged as a standard keyboard. The touching keyboard can be arranged into proper style according to applications, for example, to be arranged as a number keyboard. Besides, the touch input panel can be a flexible panel.

To sum up, in the touch keyboard of present invention, the tracking input zone is formed among at least two key zones and used as an alternative input interface in addition to keystroke. Therefore, the touch keyboard allows the user to operate the keystroke button, and simultaneously operate a non-keystroke input as an alternative interface. The tracking input zone can be located in the center of the touch input surface, for example, to locate among keys G, H, and Y, or among keys G, T, and Y, so as to enhance utilization convenience, e.g. using the index finger to slip over the tracking input zone to generate the input signals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch keyboard, comprising:
a touch input panel, having a touch input surface, a plurality of key zones and a tracking input zone, and physically presenting the plurality of key zones on the touch input surface, wherein the tracking input zone is located between at least two of the key zones.

2. The touch keyboard of claim 1, wherein the tracking input zone is located in a center of the touch input surface.

3. The touch keyboard of claim 1, wherein the tracking input zone is physically presented on the touch input surface.

4. The touch keyboard of claim 3, wherein the tracking input zone is defined by a contour, and the contour comprises a shape of a circle, a triangle, a rectangle, a pentagon, a hexagon, or a star.

5. The touch keyboard of claim 1, wherein the tracking input zone is located among key zones corresponding to keys Y, U, and H, or among key zones corresponding to keys Y, G, and H.

6. The touch keyboard of claim 1, wherein a contour of the tracking input zone and the outlines of key zones near to the tracking input zone correspond to each other.

7. The touch keyboard of claim 1, wherein the tracking input zone is not physically presented on the touch input surface, and the outlines of key zones near to the tracking input zone indicate a position of the tracking input zone.

8. The touch keyboard of claim 1, further comprising:
a housing, containing the touch input panel.

9. The touch keyboard of claim 1, wherein a gap is formed among the plurality of key zones, and the touch input panel further comprises:
a plurality of row conducting wires and a plurality of column conducting wires, interlacedly arranged;
wherein each of the key zones covers at least one cross point of the plurality of row conducting wires and the plurality of column conducting wires.

10. The touch keyboard of claim 1, wherein the touch input panel is a resistive touch panel or a capacitive touch panel.

11. The touch keyboard of claim 1, wherein the touch input panel is a flexible touch input panel.
